(19) United States
(12) Patent Application Publication
(10) Pub. No.: US 2013/0346326 A1
(43) Pub. Date: Dec. 26, 2013

(54) PAY TO PLAY COMPLIANCE SYSTEM AND METHOD

(71) Applicant: MASSACHUSETTS MUTUAL LIFE INSURANCE COMPANY, Springfield, MA (US)

(72) Inventors: Hugh Barrett, Springfield, MA (US); Tanya Ellen Lane, West Springfield, MA (US); Janet DeGazon, Springfield, MA (US)

(73) Assignee: Massachusetts Mutual Life Insurance Company, Springfield, MA (US)

(21) Appl. No.: 13/705,660

(22) Filed: Dec. 5, 2012

Related U.S. Application Data
(63) Continuation of application No. 12/935,395, filed on Jun. 25, 2012.

(51) Int. Cl. G06Q 30/00

(52) U.S. Cl. CPC G06Q 30/018
USPC 705/317

(57) ABSTRACT

A system and method for ensuring compliance with pay-to-play laws. In one embodiment of the invention, the computer-implemented system and method facilitates compliance with pay-to-play laws of different jurisdictions having varying requirements. The pay-to-play compliance system and method also provides reporting functionality, and integration with other internal databases and systems in order to minimize the amount of information required to be entered by a user. In addition, the compliance system supports a refund mechanism whereby an individual who has over-contributed can report a refund amount consistent with pay-to-play laws.

### CROSS-REFERENCE TO RELATED APPLICATION

This application claims priority to and the benefit of U.S. nonprovisional patent application with Ser. No. 12/953,395, filed Nov. 23, 2010 and entitled “Pay-to-Play Compliance System and Method,” the entirety of which is incorporated by reference herein.

### TECHNICAL FIELD

The present invention is in the field of computer-based systems and methods of ensuring compliance with laws. More particularly, the present invention is in the technical field of computer-based systems and methods in facilitating, determining and ensuring compliance with “pay-to-play” laws and regulations.

### BACKGROUND OF THE INVENTION

The United States federal government and all fifty states, directly or indirectly, prohibit bribery in obtaining government contracts. The federal government and many states and regulatory bodies have implemented so called “pay-to-play” restrictions through new or amended campaign finance, ethics, anti-bribery laws and/or regulations including procurement regulations, executive orders, policy statements, disclosure requirements, and contract terms or certifications (“pay-to-play restrictions”) to help regulate the influence that those who do business with a government entity can wield through political campaign contributions. Such pay-to-play restrictions limit state contractors or prospective state contractors, their affiliated entities including other companies or connected political action committees (separate segregated funds), and can even impact certain employees' and covered family members' ability to give a personal political contribution or undertake a solicitation on behalf of a candidate for office. Additionally, such pay-to-play restrictions may also require disclosure of certain current or past political contributions as a contingency of being awarded or maintaining a government contract, or as a means for regulators to ensure compliance with the applicable pay-to-play restrictions.

Ensuring compliance with all of these laws, however, can be difficult given the many differences that exist in the many state, local, and federal laws and regulations. This complexity is even more evident when a corporation or other business entity, including but not limited to limited liability companies, limited liability partnerships, partnerships, sole proprietorships, or any other organized business concern, conducts business activity in many jurisdictions, and must ensure that its employees and board directors comply with multiple pay-to-play restrictions at the same time. It is often unclear whether a state ethics agency, elections agency, or state contracting agency is responsible for enforcing the laws. It is also difficult for individual employees and board members, and in some instances certain employees' or board members' covered family members who work for organizations affected by pay-to-play rules, to determine their own eligibility to give personal political contributions to state, local, or government entities. Additional complexity is added due to variations in pay-to-play restrictions including: different dollar limits and thresholds on the amount of a political contribution or solicitation; whether the entity seeking the governmental business is deemed by the applicable rule to meet the threshold of “contractor” or “prospective contractor” status and therefore covered by the rule; whether an employee is covered by the applicable rule due to their title or job function within the contracting entity; whether those employees or covered family members are legally entitled to vote for a particular government official or candidate for office; whether the candidate to whom the contribution is being made meets the definition of a covered official within the law or rule either by their title or ability to influence directly or indirectly the selection of the government contractor; and the timing of a political contribution in relation to the solicitation, request for proposal, or awarding of the contract.

Currently, many corporations utilize a legal compliance administrator, often a lawyer, who is familiar with the vast universe of different pay-to-play restrictions and is tasked with ensuring compliance both on an individual basis among the employees, and on a company-wide basis. This administrator must field a large number of inquiries from employees seeking approval of their personal political contributions to avoid violating pay-to-play restrictions. As the number and complexity of these restrictions increases, the job of the legal administrator becomes more complicated and burdensome. Simultaneously, the risks of non-compliance for the company and for the individual employees continue to increase, and can include civil and criminal penalties, loss of existing contracts, surrendering compensation or fees earned for those contracts, or being debarred from bidding on other governmental contracts for a certain time period.

The traditional method of utilizing a legal administrator to answer every employee question is a disadvantage because the administrator often must field a large volume of inquiries, many of which may be repeat questions from different employees that the administrator must answer. The legal administrator must often conduct research into an employee's inquiry, and that research may be duplicated many times over if employees request pre-approval of similar personal political donations. The traditional method of using a legal administrator is also a disadvantage because the administrator must manually answer every employee inquiry, which can be time-consuming and burdensome as the number of employees and employee inquiries increases. In addition, a manual system provides no easy means of recordkeeping requests and approvals for future reporting, auditing, and disclosure to regulators.

The disclosed computer-based systems and methods of facilitating, determining and ensuring compliance with pay-to-play laws and regulations is directed at overcoming one or more of the problems listed above.

### SUMMARY OF THE INVENTION

In one aspect of the present invention, a computer-implemented method is provided for complying with a plurality of pay-to-play laws of a plurality of jurisdictions having a plurality of requirements. The method includes entering, by a first user on a computer system, a plurality of questions related to compliance with pay-to-play laws; storing, in a database, the plurality of questions; entering by the first user, a plurality of restrictions related to compliance with pay-to-play laws; and storing in a database the plurality of restrictions. The method also includes entering, by a second user, a proposed contribution amount and recipient; storing in a database the proposed contribution amount and recipient; presenting the plurality of questions to the second user; receiving answers from the second user in response to the plurality of questions; and storing in a database the answers from the second user. The method further includes retrieving information regarding the second user from an internal database or system and determining a compliance status using the computer system. The compliance status is determined based at least in part on the information regarding the second user retrieved from the internal database or system, the stored answers, and the stored restrictions. Finally, the method includes sending the compliance status to an output device of the computer system.

In one embodiment, the second user is an employee of a company.

In another embodiment, the method includes providing the second user with a list of all of the second user's previous contributions.

In a further embodiment, the first user of the computer system is a legal administrator.

In yet a further embodiment, the method includes a step of allowing an update of the plurality of restrictions based on a change in the pay-to-play laws of at least one jurisdiction.

In another embodiment, a computer-implemented method is provided for complying with a plurality of pay-to-play laws of a plurality of jurisdictions having a plurality of requirements. The method includes the steps of entering, by a first user on a computer system, a plurality of questions related to compliance with pay-to-play laws. The method also includes storing, in a database, the plurality of questions; entering, by the first user, a plurality of restrictions related to compliance with pay-to-play laws; storing, in a database, the plurality of restrictions; entering, by a second user, a proposed contribution amount and recipient; and storing, in a database, the proposed contribution amount and recipient. Further, the method includes presenting, by a computer system, the plurality of questions to the second user; receiving answers from the second user in response to the plurality of questions; storing, in a database, the answers from the second user; and determining a compliance status using the computer system. The compliance status is determined based at least in part on comparing the stored answers to the stored restrictions. The method includes sending the compliance status to an output device of the computer system; entering, by the second user, an amount of a refund to be applied to a specific contribution; and storing, in a database, the refund amount entered by the second user.

In one aspect of the present invention, the second user is an employee of a company.

In another embodiment, the method includes providing the second user with a list of all of the second user's previous contributions.

In a further embodiment, the first user of the computer system is a legal administrator.

In yet a further embodiment, the method includes a step of allowing an update of the plurality of restrictions based on a change in the pay-to-play laws of at least one jurisdiction.

In another embodiment of the present invention, a computer system is provided for complying with a plurality of pay-to-play laws of a plurality of jurisdictions having a plurality of requirements. The system includes a first receiving module configured to receive a plurality of questions related to compliance with pay-to-play laws from a first user of the computer system, and a database module configured to store the plurality of questions. The system also includes a second receiving module configured to receive a plurality of restrictions related to compliance with pay-to-play laws from the first user, and a database module configured to store the plurality of restrictions. The system further includes a third receiving module configured to receive a proposed contribution amount and recipient from a second user, and a database module configured to store the proposed contribution amount and recipient. The system includes a presentation module configured to present the plurality of questions to the second user, and a fourth receiving module configured to receive answers from the second user in response to the plurality of questions (along with a database module configured to store the answers from the second user). The system includes a retrieving module configured to retrieve information regarding the second user from an internal database or system, and a compliance module configured to determine a compliance status. The compliance status is determined based at least in part on the information regarding the second user retrieved from the internal database or system, the stored answers, and the stored restrictions. Finally, the system includes an output module configured to send the compliance status to an output device of the computer system.

In one aspect of the present invention, the second user is an employee of a company.

In another embodiment, the system includes a reporting module configured to provide the second user with a list of all of the second user's previous contributions.

In a further embodiment, the first user of the computer system is a legal administrator.

In yet a further embodiment, the system includes an update module configured to allow an update of the plurality of restrictions based on a change in the pay-to-play laws of at least one jurisdiction.

In another embodiment, a computer system is provided for complying with a plurality of pay-to-play laws of a plurality of jurisdictions having a plurality of requirements. The system includes a first receiving module configured to receive a plurality of questions related to compliance with pay-to-play laws from a first user, and a database module configured to store the plurality of questions. The system also includes a second receiving module configured to receive a plurality of restrictions related to compliance with pay-to-play laws from the first user, and a database module configured to store the plurality of restrictions. The system also includes a third receiving module configured to receive a proposed contribution amount and recipient from a second user, a database module configured to store the proposed contribution amount and recipient, and a presentation module configured to present, by the computer system, the plurality of questions to the second user. In addition, the system includes a fourth receiving module configured to receive answers from the second user in response to the plurality of questions, and a database module configured to store the answers from the second user. A compliance module is included that is configured to determine a compliance status, with the compliance status being determined based at least in part on comparing the stored answers to the stored restrictions. The system further includes an output module configured to send the compliance status to an output device of the computer system, a refund module configured to receive an amount of a refund to be applied to a specific contribution from the second user, and a database module configured to store the refund amount entered by the second user.

In one aspect of the present invention, the second user is an employee of a company.

In another embodiment, the system includes a reporting module configured to provide the second user with a list of all of the second user's previous contributions.

In a further embodiment, the first user of the computer system is a legal administrator.

In yet a further embodiment, the system includes an update module configured to allow an update of the plurality of restrictions based on a change in the pay-to-play laws of at least one jurisdiction.

### BRIEF DESCRIPTION OF THE DRAWINGS

FIG. 1 is a diagram of an architecture for a typical system according to the present invention.

FIG. 2 is a flow chart of steps in a typical process according to the present invention.

FIG. 3 is another flow chart of steps in a typical process according to the present invention.

### DETAILED DESCRIPTION OF THE INVENTION

The present application is directed toward computer-based systems and methods of determining and ensuring compliance with pay-to-play laws and regulations.

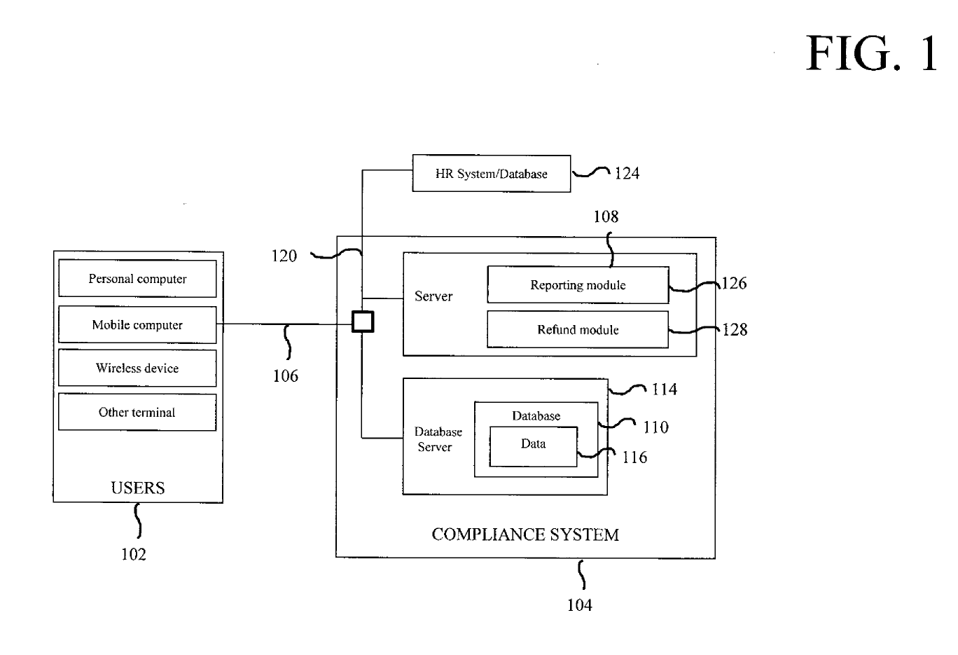

Referring now to FIG. 1, one embodiment of a system of the present invention is depicted. Users may utilize any one of a number of compatible devices 102 to interact with the compliance system 104 via an operative connection 106. Users of the compliance system may include: legal administrators who formulate and maintain the questions, answer choices, and restrictions that will be used to generate an automated pre-approval decision based on an employee's responses to the questions; employees who will answer questions when prompted and receive an automated pre-approval decision; and any other users who may need access to the compliance system 104. Compatible devices 102 include personal computers, mobile computers, wireless devices, terminals, or any other type of electronic device. Devices 102 may include a keyboard, mouse, touch screen, or any other type of user input device, and may also include a monitor, television, printer, or any other type of output device.

As used in FIG. 1 and the following figures and descriptions, “operative connection” or “operative communication” includes any type of wired or wireless communication, including but not limited to the Internet, local area networks, wide area networks, wireless networks, telephone lines, satellite communication, or any such type of electronic communication capable of transmitting and receiving data. In a preferred embodiment, operative connection 106 may comprise the Internet.

A typical compliance system 104 includes at least one server 108 for implementing and controlling compliance system 104. A typical compliance system 104 may also include at least one database 110 for storing data associated with the compliance system 104, such as questions, answers, employee response records, generated reports, compliance data, or any other electronic record desired to be stored. Database 110, in a typical embodiment, may use one or more data servers 114 and one or more internal or external data storage devices 116, as described below.

The compliance system 104 may also include an operative connection 120, such as an internal Ethernet network, which supports communication between the various components of the compliance system 104. Operative connection 120 may include any suitable communication architecture including, but not limited to, a computer network such as a Ethernet, token ring network, the Internet, a direct connection such as a bus connection, parallel, or serial connection, null modem connection, dedicated line, or wireless connection utilizing any appropriate communication protocol known in the art. In embodiments where a single computer may provide all functional components of compliance system 104, the communication along operative connection 120 may occur via bus connections, inter-process communication, shared files, or any combination of these methods (or any other commonly used single-computer communication mechanisms).

The compliance system 104 may include at least one server 108 that provides compliance system functionality. This, or other servers (not shown), may enable and support access to the compliance system by the users utilizing compatible devices 102. Access to the compliance system by these users may be via any suitable operative connection 106, which in one preferred embodiment will be a computer network such as the Internet. In other embodiments, access may be via other forms of computer network, direct dial-up connection, dedicated connection, direct or indirect connection such as via a bus connection, parallel or serial connection, null modem connection, or wireless connection utilizing an appropriate communication protocol known to those skilled in the art. The at least one server 108 may include or connect to database 110. In one embodiment, server 108 and database 110 may be joined together in a single computer system that comprises compliance system 104. The conveyance of data and information to and from users utilizing devices 102 occurs via the operative connection 106.

The compliance system 104 may also include connectivity 120 from the one or more servers 108 to any number of external systems or databases, such as for instance, an external human resources system or database 124. Operative connection 120 may allow the at least one server 108 to communicate with the external system or database 124, via operative connection 120. The connection from the compliance system 104 to the human resources database 124 may facilitate the gathering of data regarding employees, such that an “employee status” may be calculated by determining whether the employee matches any parameters such that regulatory compliance is a concern. For instance, under some regulatory schemes, only certain employees are considered to be “covered associates” such that particular regulations apply to those employees.

The one or more servers 108 might also include any number of modules for performing other various functions. For instance, server 108 might include a reporting module 126 that is capable of providing both management reports and regulatory reports. In a preferred embodiment, the reporting module 126 may include capabilities to provide management reports by allowing a user to input data in order to retrieve information corresponding to a date range, entity, state, whether the individual (or individuals) is covered or not-covered, and the status of any individual's inquiry (e.g., approved, pending, declined, or approved but not confirmed). The report may be generated in any format desired, such as an Excel spreadsheet, pdf document, Word document, etc. The report information may include a tracking number, user information, answers to questions, and the proposed, confirmed, and refund dates and amounts, plus any other data as desired.

In another embodiment, the reporting module 126 may also include regulatory reporting functionality specific to particular regulations as defined by business logic incorporated in the reporting module 126. In this case, the reporting module 126 may interface with the human resources system or database 124 in order to gather any necessary data and provide reports.

As another example, server 108 might include a refund module 128, in the event that an employee has contributed over an approved amount. An employee contributing over an approved amount could happen in various situations. For instance, this might occur when an employee contributes an amount before requesting pay-to-play authorization, and in that way, has contributed over the allowed amount. In another instance, the compliance system 104 might have previously contained incorrect figures or business logic, and as such, the compliance system 104 might have inadvertently approved a contribution amount that should not have been approved. In all cases of employee over-contribution, it is beneficial to have functionality for recording refunds. In a preferred embodiment, the refund module will provide a refund page that will display the tracking number, the employee's non-editable answers to questions, the date and the amount of the contribution (non-editable), and the user will be able to enter the refund amount, refund date, and any associated comments.

The compliance system 104, as shown in FIG. 1, uses both operative connection 106 and operative connection 120 as communication channels allowing access to the compliance systems 104 by users using devices 102. A router (not shown) may be included in the compliance system 104 to manage communication within the internal operative connection 120 as well as to manage the interface between the internal operative connection 120 and the operative connection 106. In another embodiment, operative connection 106 and operative connection 120 may comprise a single communication device or channel.

The at least one server 108 may provide the desired functionality of the compliance system 104. In some embodiments, the server 108 may be divided into access servers and application servers where the access servers provide electronic access functionality such as by electronic mail server(s) and/or Web server(s) and the application servers provide the desired system functionality. In some embodiments, system and/or access functionality may be distributed across multiple processing elements. The term “processing element” may be a process running on a particular piece, or across particular pieces of hardware, a particular piece of hardware, or either as the context allows.

The database 110 provides for the storage and the management of the data required by the compliance system 104. In one embodiment, a database 110 may include one or more storage devices 116, and in some embodiments, it may also include one or more data servers 114 to receive and service data requests. The database depicted in FIG. 1 uses one data server 114 and several data storage devices 116. The data storage devices 116 may be located internally or externally. These depictions are representative only, and other database architectures of the present invention may comprise single, multiple and/or varied servers and storage elements. In embodiments where a single processor supports all functionality of the compliance system 104, a local hard disk drive may serve as the database 110 and a disk operating system executing on the single processor acting as a data server may support, receive, and service data requests.

The data is stored in database 110 as needed to perform the compliance functions of system 104. Data may be deleted from database 110 when no longer required by compliance system 104. The data or portions of the data in database 110 may also be shared and copied by other data management systems. For example, copies of the data in database 110 may be retained for backup and to comply with other business record retention policies. For example, data from database 110 including data such a communications between users 102 and compliance system 104 may be provided to another database such as the external system or database 124.

Information concerning different users (e.g., legal administrators, legal reviewers, and employees) and all data necessary to implement the present invention (e.g., questionnaire records, employee answer records, and compliance restrictions) may be stored in the database 110. In some embodiments, content supporting the compliance process and policy determinations may be developed, provided and maintained by a legal administrator. In such embodiments, this content may be stored in database 110, and may be updated on a periodic basis, as required by changes in law, upon demand, or at any time as determined by the legal administrator. In another embodiment, user access data is stored in a secondary storage mechanism, separate from the database 110.

The compliance system 104 may also provide a mechanism for a legal administrator 201 to input restrictions in such a way that is meaningful to the legal administrator 201 and also easily accessible for the compliance system 104 for evaluation. This may be done in addition to compliance system 104 communication with any external system or database, such as the human resources system or database 124. In one embodiment the compliance system 104 would assign all relevant political entities a unique identifier and allow the legal administrator 201 to select a combination of such identifiers that would result in a “not permissible” decision for the users of the system. In such an embodiment, a separate system could be used to automatically receive feeds from public sources to populate said political entities and their identifiers. In another embodiment, the legal administrator 201 could input a set of free-form conditions for the compliance system 104 to interpret and check, and these conditions could include a custom grammar specifically designed for the purpose of evaluation, such as “amount>$1000” or “firstname is john and lastname is smith”.

In one embodiment, compliance system 104 may include additional operative connections to enable additional functionality and interactions with existing hardware and software (both inter-company and third-party). For example, compliance system 104 may include a database link to a sales database, contacts database, contracts database, client database, or other internal databases, to determine whether the proposed recipient of contributions (i.e., candidate for elected or appointed office) is an official of an existing governmental client.

In another embodiment, compliance system 104 may be accessed via an external password protected website to allow candidates for employment to report or log their past contributions into compliance system 104, which would then compare any past contributions with applicable laws and regulations input by legal administrator 201, such as those regarding various look-back provisions in the pay-to-play laws or regulations.

It will be understood by those of ordinary skill in the art that these different types of information and data may be logically or physically segregated within a single system database; multiple related databases accessible through a unified management system, which together serve as the system database; or multiple independent databases individually accessible through disparate management systems, which may in some embodiments be collectively viewed as the system database. The various storage elements that comprise the physical architecture of the system database may be centrally located, or distributed across a variety of diverse locations.

Various methods and functions as exhibited in various embodiments according to the present invention are described below with respect to pay-to-play compliance, including automated pre-approval of employee personal political contributions based on restrictions input by the legal administrator, review of the automated pre-approval decisions, and manual modification or override of the automated pre-approval decision as deemed necessary by the legal administrator. In some embodiments, one or more processors within architectures of the environments as described above may execute the steps in such methods and provide such functionality. The functionality may be spread across multiple processing elements; in certain embodiments, these processing elements may logically and/or physically be divided into access, compliance logic, and data storage processing elements where functionality is allocated appropriately among such processing elements. In other embodiments, any suitable computer readable storage device, including primary storage such as RAM, ROM, cache memory, etc., or secondary storage, such as magnetic media including fixed and removable disks and tapes; optical media including fixed and removable disks whether read-only or read-write; or other secondary storage as would be known to those skilled in the art, may store instructions that upon execution by one or more processors cause the one or more processors to execute the steps in such methods and to provide such functionality.

### “Pay-to-Play” Legal Compliance, Evaluation, Review and Establishment

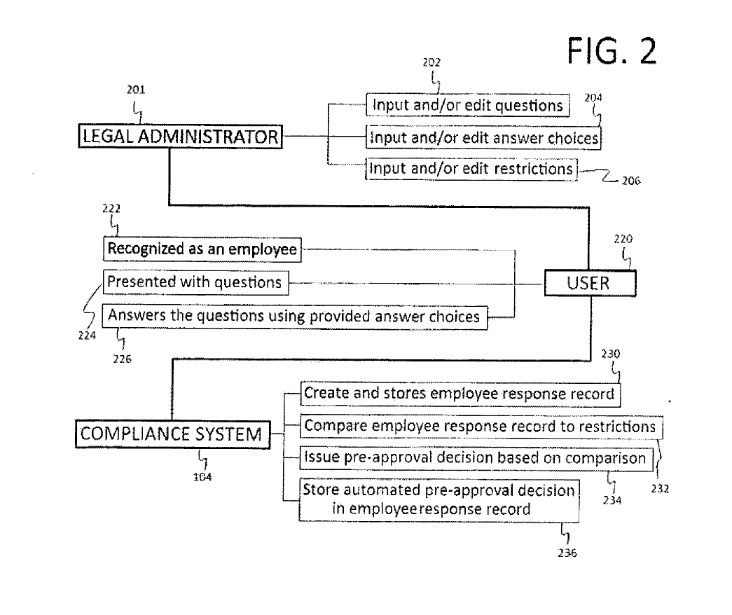

FIG. 2 is a flow chart depicting the steps in one possible embodiment of the present invention. A legal administrator 201, using a compatible device 102, accesses the compliance system 104. The legal administrator 201 inputs or edits a number of questions at 202 that will be presented to employees who seek pre-approval of their personal political contributions. The questions may inquire about, for example: the planned jurisdiction of the contribution; the planned recipient of the contribution; the company, department, or group in which the employee works; the employee's title in the company; whether the employee works in sales, marketing, business development, or a similar job; whether the employee's job responsibilities include investment advisory functions; whether the employee's job responsibilities include managerial oversight of public contracts or investments; whether the employee's job responsibilities require them to interact with public officials, state, local or municipal agencies regarding sales or contract matters; and whether the employee requesting clearance is requesting it on behalf of themselves or a covered family member. In addition to inputting and editing questions, at 204 the legal administrator also chooses from a variety of answer formats that the application would present to an employee for each question. For example, questions may have multiple choice answers, free form answers in which an employee can input a custom answer, yes/no answers, or any other combination of answer choices which the legal administrator deems appropriate for a given question. Additionally, after the initial list of questions and answers is created at 202 and 204, the legal administrator may return to those steps, at any time, to further input or edit the questions and answers. Such edits may include inputting new questions, updating current questions, deleting current questions, and changing the available answer options presented to a user.

Once the questions and answers have been created by the legal administrator 201 and are stored within the compliance system database 110, the legal administrator 201 also inputs and edits any number of restrictions at 206 that, based at least in part on an employee's answers to a question or a combination of questions, will generate either a “not permissible” compliance status, notifying the employee that the planned political contribution is not allowed, or else a “permissible” compliance status, indicating at least an initial approval of the planned political contribution.

Subsequently, a user 220, using a compatible device 102, accesses the compliance system 104 and is recognized as an employee at 222. This recognition may consist of a login name and password, encryption technique, or any other method of recognition. Once recognized as an employee, the user 220 is presented with the questions at 224 created by the legal administrator 201. The user 220 may then answer the questions using the provided answer choices at 226.

Alternatively, the questions at 224 created by the legal administrator 201 may be answered by the one or more servers 120 communicating with any external (or intra-company) system or database such as the human resources system or database 124. In this situation, it is unnecessary to query the user 220 for the answers to the questions created by the legal administrator, because one or more answers to these questions may already be stored by the human resources system or database 124. For instance, the human resources system or database might already store the information used to determine whether the employer is defined as a “covered associate” pursuant to certain regulations, and as such, the system might automatically make this determination without the need for requesting information from the user 220.

In one embodiment, compliance system 104 may include additional operative connections to enable additional functionality and interactions with existing hardware and software (both intra-company and third-party). For example, as explained above, compliance system 104 may include an operative connection to the company's human resources software system and/or database to confirm the job title and/or employing entity of a user 102, and also to automate portions of the answering step at 226. As another example, compliance system 104 may include an operative connection to an external database to compare user 102's address (obtained from user 102 or a human resources database) to a list of addresses or a range of addresses entitled to vote for specific candidates. Such a feature could facilitate compliance with laws or regulations establishing different contribution limits based on an employee's residence and ability to vote for specific candidates.

Once the user 220 has provided an answer to the questions at 226, the compliance system 104 creates an employee response record and stores the answers and any other desired additional information in the employee response record at 230. The compliance system 104 may then compare the employee response record at 230 to the restrictions input by the legal administrator 201 at 206 to determine the appropriate compliance status at 232. Once the employee response record and the restrictions have been compared, the compliance system 104 may provide the user 220 with a compliance status decision based on the comparison. For example, if a user 220 indicates through his answers at 226 that he would like to donate $1000 to a candidate running for state representative in Connecticut, and the legal administrator 201 has input a restriction at 206 that does not permit contributions to state representative candidates in Connecticut in excess of $500, the compliance system 104 will return a “not permissible” compliance status at 234 to the user 220. If, however, a user's answers at 226 do not violate any of the input restrictions at 206 created by the legal administrator 201, the compliance system 104 may issue a “permissible” compliance status at 234 indicating to the user 220 that their planned political contribution does not violate any of the pay-to-play restrictions currently input by the legal administrator 201 into the compliance system 104. Once complete, the compliance system 104 may store the determined compliance status it issued to user 220 in the employee response record at 236.

Compliance system 104 may also include an automated notification system (not shown) which enables a user 102 to confirm, at a later date after the contribution, the date, amount, and recipient of a contribution. For example, the automated notification system may communicate with user 102 (using email, text message, or any other electronic communication) a set number of days after the initial determination of compliance status. The communication would require user 102 to reply to the communication to verify the details of the contribution to comply with record-keeping requirements of applicable laws and regulations. Failure of user 102 to confirm the contribution may result in any future requests for pre-approval of a compliance status being denied or blocked.

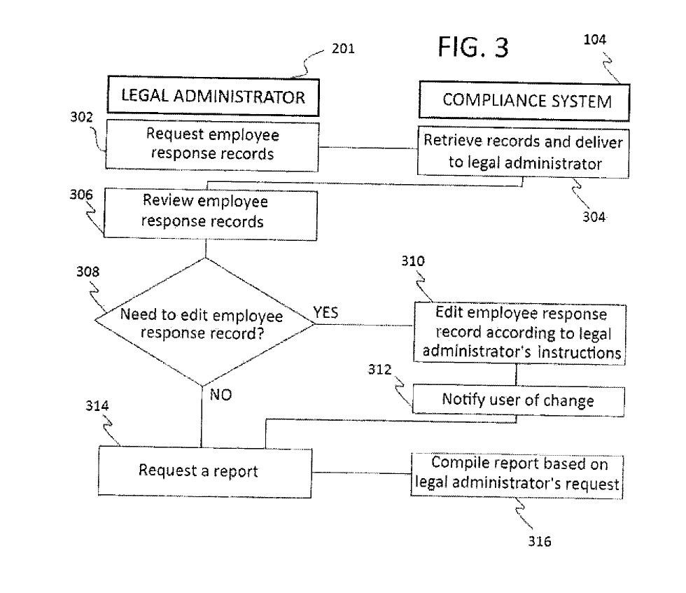

Referring now to FIG. 3, a flowchart is depicted that describes the steps in another embodiment of the present invention. The legal administrator 201 may access the compliance system 104 using any compatible device 102 and may request access to an individual employee response record or to a group of employee response records at 302. The compliance system 104 then verifies that the legal administrator 201 is authorized to view and edit the records, and upon verification, retrieves the requested records and displays them to the legal administrator 201 at 304. The legal administrator 201 may then review the employee response records at 306 and may elect to edit the pre-approval decision or add any necessary comments to the employee response record at 308. For example, if a user 220 had been issued a “not permissible” compliance status from the compliance system 104 when she first provided her answers, but circumstances have changed such that her planned political contribution would now be permissible, the legal administrator 201 can change the compliance status from “not permissible” to “permissible” at 310. Once this is completed, the legal administrator 201 may authorize the compliance system 104 to notify the user 220 of the change at 312. Alternatively, the compliance system 104 may automatically notify the user 220 of the change. Such a notification may be via email, text message, or any other type of communication.

The legal administrator 201 may then send a request at 314 to the compliance system 104 to generate a report including all of the information from all of the employee response records within the database 110, or as much of the information as the legal administrator 201 requests. The report may include numerical data, text data, delimiters, headers, or other information, and the compliance system 104 may export the data to a spreadsheet application such as Microsoft Excel, or other software applications for additional review, analysis, reporting or presentation. For example, the legal administrator 201 may request a report which contains all of the answers contained in the employee response records in which an employee wished to make a personal political contribution in a specific state or to a specific office. In another embodiment, the legal administrator 201 may request generation of a report containing only the employee names and the jurisdictions in which they requested approval for personal political contributions. Any combination of the data contained in the employee response records may be used by the compliance system 104 to generate a custom report at 316.

The embodiments described above are given as illustrative examples only. It will be readily appreciated by those skilled in the art that many deviations may be made from the specific embodiments disclosed in this specification without departing from the invention. Accordingly, the scope of the invention is to be determined by the claims below rather than being limited to the specifically described embodiments above.

1. A computer-implemented method of complying with a plurality of pay-to-play laws of a plurality of jurisdictions having a plurality of requirements, comprising the steps of:
entering, by a first user on a computer system, a plurality of questions regarding political contributions;
storing, in a database, the plurality of questions;
entering, by the first user, a plurality of restrictions imposed on political contributions by pay-to-play laws;
storing, in a database, the plurality of restrictions;
entering, by a second user, a proposed political contribution amount and candidate recipient;
storing, in a database, the proposed political contribution amount and candidate recipient;
presenting, by a computer system, the plurality of questions to the second user;
receiving, by the computer system, answers from the second user in response to the plurality of questions, the answers defining the proposed political contribution;
storing, in a database, the answers from the second user;
retrieving information regarding the second user from an internal database or system;
determining whether the proposed political contribution is in compliance with the play-to-pay laws, using the computer system, this determination based at least in part on the information regarding the second user retrieved from the internal database or system, the stored answers, and the stored restrictions; and
sending an indication of results of said determining to an output device of the computer system.

2. The method of claim 1, wherein said second user is an employee.

3. The method of claim 1, further comprising the step of providing the second user with a list of all of the second user's previous political contributions.

4. The method of claim 1, wherein said first user of said computer system is a legal administrator.

5. The method of claim 3, further comprising the step of allowing an update of the plurality of restrictions based on a change in the pay-to-play laws of at least one jurisdiction.

6. A computer-implemented method of complying with a plurality of pay-to-play laws of a plurality of jurisdictions having a plurality of requirements, comprising the steps of:
entering, by a first user on a computer system, a plurality of questions regarding political contributions;
storing, in a database, the plurality of questions;
entering, by the first user, a plurality of restrictions imposed on political contributions by pay-to-play laws;
storing, in a database, the plurality of restrictions;
entering, by a second user, a proposed political contribution amount and candidate recipient;
storing, in a database, the proposed political contribution amount and candidate recipient;
presenting, by a computer system, the plurality of questions to the second user;
receiving answers from the second user in response to the plurality of questions, the answers defining the proposed political contribution;
storing, in a database, the answers from the second user;
determining a compliance status whether the proposed political contribution is in compliance with the pay-to-play laws, using the computer system, the compliance status determined based at least in part on comparing the stored answers to the stored restrictions;
sending the compliance status to an output device of the computer system;
entering, by the second user, an amount of a refund to be applied to a specific political contribution; and
storing, in a database, the refund amount entered by the second user.

7. The method of claim 6, wherein said second user is an employee.

8. The method of claim 6, further comprising the step of providing the second user with a list of all of the second user's previous political contributions.

9. The method of claim 6, wherein said first user of said computer system is a legal administrator.

10. The method of claim 8, further comprising the step of allowing an update of the plurality of restrictions based on a change in the pay-to-play laws of at least one jurisdiction.

11. A computer system for complying with a plurality of pay-to-play laws of a plurality of jurisdictions having a plurality of requirements, the system comprising:
at least one processor; and
at least one non-transitory storage medium storing instructions that, when executed by the at least one processor, enables said at least one processor to monitor compliance with said plurality of pay-to-play laws of a plurality of jurisdictions, said instructions including:
a first receiving module configured to receive a plurality of questions regarding political contributions from a first user of the computer system;
a database module configured to store the plurality of questions;
a second receiving module configured to receive a plurality of restrictions imposed on political contributions by pay-to-play laws from the first user;
a database module configured to store the plurality of restrictions;
a third receiving module configured to receive a proposed political contribution amount and candidate recipient from a second user;
a database module configured to store the proposed political contribution amount and candidate recipient;
a presentation module configured to present, by the computer system, the plurality of questions to the second user;
a fourth receiving module configured to receive answers from the second user in response to the plurality of questions, the answers defining the proposed political contribution;
a database module configured to store the answers from the second user;
a retrieving module configured to retrieve information regarding the second user from an internal database or system;
a compliance module configured to determine whether the proposed political contribution is in compliance with the play-to-pay laws based at least in part on the information regarding the second user retrieved from the internal database or system, the stored answers, and the stored restrictions; and
an output module configured to send an indication of results from said compliance module to an output device of the computer system.

12. The system of claim 11, wherein said second user is an employee.

13. The system of claim 11, further comprising a reporting module configured to provide the second user with a list of all of the second user's previous political contributions.

14. The system of claim 11, wherein said first user of said computer system is a legal administrator.

15. The system of claim 13, further comprising an update module configured to allow an update of the plurality of restrictions based on a change in the pay-to-play laws of at least one jurisdiction.

16. A computer system for complying with a plurality of pay-to-play laws of a plurality of jurisdictions having a plurality of requirements, the system comprising:
at least one processor; and
at least one non-transitory storage medium storing instructions that, when executed by the at least one processor, enables said at least one processor to monitor compliance with said plurality of pay-to-play laws of a plurality of jurisdictions, said instructions including:
a first receiving module configured to receive a plurality of questions regarding political contributions from a first user;
a database module configured to store the plurality of questions;
a second receiving module configured to receive a plurality of restrictions imposed on political contributions by pay-to-play laws from the first user;
a database module configured to store the plurality of restrictions;
a third receiving module configured to receive a proposed political contribution amount and candidate recipient from a second user;
a database module configured to store the proposed political contribution amount and candidate recipient;
a presentation module configured to present, by the computer system, the plurality of questions to the second user;
a fourth receiving module configured to receive answers from the second user in response to the plurality of questions, the answers defining the proposed political contribution;
a database module configured to store the answers from the second user;
a compliance module configured to determine a compliance status whether the proposed political contribution is in compliance with the pay-to-play laws, the compliance status determined based at least in part on comparing the stored answers to the stored restrictions;
an output module configured to send the compliance status to an output device of the computer system;
a refund module configured to receive an amount of a refund to be applied to a specific political contribution from the second user; and
a database module configured to store the refund amount entered by the second user.

17. The system of claim 16, wherein said second user is an employee.

18. The system of claim 16, further comprising a reporting module configured to provide the second user with a list of all of the second user's previous political contributions.

19. The system of claim 16, wherein said first user of said computer system is a legal administrator.

20. The system of claim 18, further comprising an update module configured to allow an update of the plurality of restrictions based on a change in the pay-to-play laws of at least one jurisdiction.
